(19) United States
(12) Patent Application Publication
(10) Pub. No.: US 2024/0193650 A1
(43) Pub. Date: Jun. 13, 2024

(54) METHOD, DEVICE AND COMPUTER-READABLE STORAGE MEDIUM FOR DATA TRANSFER AND CIRCULATION

(71) Applicant: Chengdu Xijianwen Technology Consulting Co., Ltd, Chengdu (CN)

(72) Inventors: Juan HE, Chengdu (CN); Zhengbo LI, Chengdu (CN); Xiwen WANG, Chengdu (CN)

(21) Appl. No.: 18/585,126

(22) Filed: Feb. 23, 2024

(30) Foreign Application Priority Data
Feb. 23, 2023 (CN) 202310155069.0

(51) Int. Cl. G06Q 30/04; G06Q 10/0631; H04L 9/00

(52) U.S. Cl. CPC G06Q 30/04; G06Q 10/0631; H04L 9/50; G06Q 2220/00

(57) ABSTRACT

A data transfer and circulation method is performed as follows. Blockchain certificates of multi-level supplier nodes are obtained and sent to a core enterprise node. After receiving a confirmation feedback of the user identities of the multi-level supplier nodes, the first-level supplier node sends a request for a completed work item to the core enterprise node. A completed work item digital bill of the first-level supplier node is generated based on a preset smart contract and the completed work item. The multi-level supplier nodes generate credit transfer digital certificates based on the preset smart contract. The multi-level supplier nodes request factoring information from a factor node based on the credit transfer digital certificates. A device and a computer-readable storage medium for data transfer and circulation are also provided.

### CROSS-REFERENCE TO RELATED APPLICATIONS

This application claims the benefit of priority from Chinese Patent Application No. 202310155069.0, filed on Feb. 23, 2023. The content of the aforementioned application, including any intervening amendments made thereto, is incorporated herein by reference in its entirety.

### TECHNICAL FIELD

This application relates to data transfer and circulation, and more particularly to a method, device and computer-readable storage medium for data transfer and circulation.

### BACKGROUND

Currently, the infrastructure sector has attracted numerous ecological enterprises and has become a hotly contested spot for financial institutions. However, due to its large capital requirements, complex business models and common advance payment, the settlement cycles of engineering are long, particularly resulting in the low efficiency of settling work item accounts receivable.

Work item accounts receivable refers to the future accounts receivable that arises between trading parties before the existing accounts receivable is generated. The debt value of work item accounts receivable is determined by real transaction contracts, transaction forms, transaction data and other completed work item data information of the two parties involved in the transaction. In practice, work item accounts receivable can be transferred among suppliers, but the prior art lacks a method to specifically describe the transfer of work item accounts receivable which results in two main problems. Firstly, the information on the value of work item accounts receivable is opaque and lacks credibility. Secondly, efficiency in capital transfer is low because the transfer of the value of work item accounts receivable cannot be visualized.

Therefore, there is an urgent need for a data transfer and circulation method to enhance the credibility of completed work volumes by promoting the transparency of information on the value of work item accounts receivable in the entire chain, and improve the efficiency of capital transfer by realizing the visualization of the transfer of the value of work item accounts receivable.

### SUMMARY

An object of the present disclosure is to provide a data transfer and circulation method, device, system, and computer-readable storage medium to address the above-mentioned defects. To achieve the above purpose, the technical solutions adopted by the present disclosure are as follows.

In a first aspect, the present disclosure provides a data transfer and circulation method, comprising:
obtaining blockchain certificates respectively corresponding to multi-level supplier nodes;
sending the blockchain certificates to a core enterprise node, wherein the blockchain certificates are configured to trigger the core enterprise node to confirm user identities of the multi-level supplier nodes;
after receiving a confirmation feedback of the user identities of the multi-level supplier nodes sent from the core enterprise node, sending, by a first-level supplier node among the multi-level supplier nodes, a request for a completed work item to the core enterprise node;
obtaining a completed work item of the first-level supplier node, and generating a completed work item digital bill of the first-level supplier node based on a preset smart contract and the completed work item of the first-level supplier node;
performing one or more transfers among the multi-level supplier nodes according to the completed work item digital bill, and generating credit transfer digital certificates respectively corresponding to different levels of the multi-level supplier nodes based on the preset smart contract during a transfer process; and
requesting, by the multi-level supplier nodes, factoring information from a factor node based on the credit transfer digital certificates.

In a second aspect, the present disclosure also provides a data transfer and circulation device, comprising:
a first obtaining module;
a first sending module;
a second sending module;
a second obtaining module;
a first processing module; and
a second processing module;
wherein the first obtaining module is configured for obtaining blockchain certificates respectively corresponding to multi-level supplier nodes;
the first sending module is configured for sending the blockchain certificates to a core enterprise node, wherein the blockchain certificates are configured to trigger the core enterprise node to confirm user identities of the multi-level supplier nodes;
the second sending module is configured for allowing a first-level supplier node among the multi-level supplier nodes to send a request for a completed work item to the core enterprise node after receiving a confirmation feedback of the user identities of the multi-level supplier nodes sent from the core enterprise node;
the second obtaining module is configured for obtaining a completed work item of the first-level supplier node, and generating a completed work item digital bill of the first-level supplier node based on a preset smart contract and the completed work item of the first-level supplier node;
the first processing module is configured for performing one or more transfers among the multi-level supplier nodes according to the completed work item digital bill, and generating credit transfer digital certificates respectively corresponding to different levels of the multi-level supplier nodes based on the preset smart contract during a transfer process; and
the second processing module is configured for allowing the multi-level supplier nodes to request factoring information from a factor node based on the credit transfer digital certificates.

In a third aspect, the present disclosure also provides a data transfer and circulation system, comprising:
a memory; and
a processor;
wherein the memory is configured for storing a computer program; and
the processor is configured for executing the computer program to implement the data transfer and circulation method described above.

In a fourth aspect, the present disclosure also provides a computer-readable storage medium, wherein a computer program is stored on the computer-readable storage medium, and the computer program is configured to be executed by a processor to implement the data transfer and circulation method described above.

The present disclosure provides a data transfer and circulation method, specifically a method for achieving online transfer of future accounts receivable based on completed work items, where various levels of suppliers, factoring agencies, and core enterprises transfer the future accounts receivable (i.e., work item accounts receivable) value on a public blockchain. In this method, a complete mechanism of authentication, encryption, and signing is formed using blockchain technology, promoting the transparency of the entire chain of information regarding the value of work volume accounts receivable. By leveraging the notarization function of blockchain, the completed work item is stored on the chain to enhance its credibility. The method achieves the visualization of the circulation of the value of work volume accounts receivable and improves the efficiency of fund transfer.

### BRIEF DESCRIPTION OF THE DRAWINGS

FIG. 1 is a flowchart of a data transfer and circulation method according to an embodiment of the present disclosure.

FIG. 2 is a principle diagram of a completed work item digital bill transfer structure according to an embodiment of the present disclosure.

FIG. 3 is a timing diagram of the credit transfer of a completed work item digital bill according to an embodiment of the present disclosure.

FIG. 4 is a schematic structural diagram of a data transfer and circulation device according to an embodiment of the present disclosure.

FIG. 5 is a schematic structural diagram of a first processing module according to an embodiment of the present disclosure.

FIG. 6 is a schematic structural diagram of a data transfer and circulation device according to an embodiment of the present disclosure.

In the figures: 900—first obtaining module; 901—first sending module; 902—second sending module; 903—second obtaining module; 904—first processing module; 905—second processing module; 9001—first computing unit; 9002—second computing unit; 9003—third computing unit; 9004—fourth computing unit; 9031—fifth computing unit; 9032—sixth computing unit; 9033—seventh computing unit; 9034—eighth computing unit; 9041—first transfer module; 90411—first processing unit; 90412—first encryption unit; 90413—first sending unit; 90414—first verification unit; 90415—second processing unit; 90416—third processing unit; 90417—fourth processing unit; 90418—fifth processing unit; 9042—second transfer module; 90421—sixth processing unit; 90422—second encryption unit; 90423—second sending unit; 90424—second verification unit; 90425—seventh processing unit; 90426—eighth processing unit; 90427—ninth processing unit; 90428—tenth processing unit; 9043—check module; 90431—first indexing unit; 90432—second indexing unit; 90433—storage unit; 800—data transfer and circulation system, 801—processor; 802—memory; 803—multimedia component; 804—input/output interface; 805—communication component

### DETAILED DESCRIPTION OF EMBODIMENTS

To clarify the purpose, technical solution, and advantages of embodiments of the present disclosure, the technical solution in the embodiments of the present disclosure will be clearly and completely described below with reference to the accompanying drawings of the present disclosure. Obviously, the embodiments described below are merely some, but not all, embodiments of the present disclosure. The terminologies “first”, “second”, etc., used in the description of the present disclosure are only used to distinguish descriptions and cannot be understood as indicating or implying relative importance.

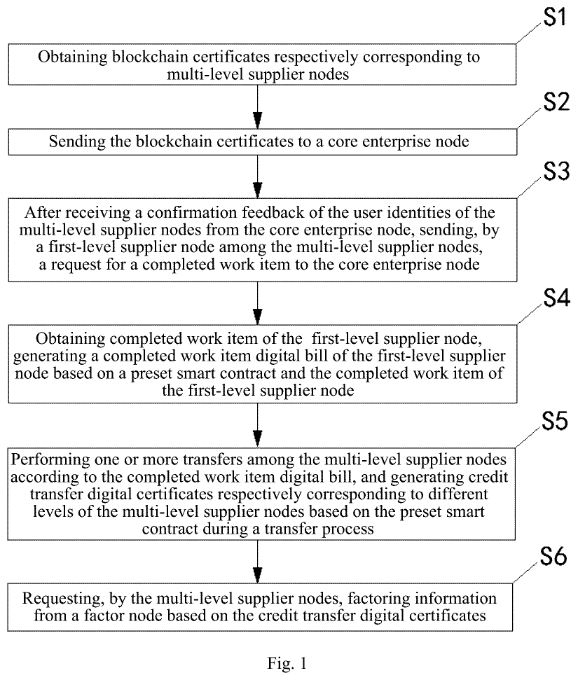

A data transfer and circulation method according to one embodiment of the present disclosure is shown in FIG. 1, which is performed through steps S1-S6.

(S1) Blockchain certificates respectively corresponding to multi-level supplier nodes are obtained.

Further, exemplified by obtaining the blockchain certificate corresponding to a first-level supplier node among the multi-level supplier nodes, the step (S1) includes the following sub-steps S11-S14.

(S11) The first-level supplier node randomly generates a first data.

Specifically, the first-level supplier node (S₁) determines a number from a large random number as the first data (x₁), and x₁∈(1, n).

(S12) A primitive root information of the first-level supplier node is determined based on the first data, and the primitive root information is sent to the core enterprise node. Then, the primitive root information is configured to trigger the core enterprise node to calculate a first pseudo-anonymous identifier based on a second data and perform service exposure for the first pseudo-anonymous identifier. The second data is randomly generated by the core enterprise node.

In the step (S12), the first-level supplier node (S₁) sends g^{x}^{₁} to the core enterprise node. Among them, g is the primitive root of a prime number of the first-level supplier node identified by the first data (x₁), and g^{x}^{₁} is the primitive root information of the first-level supplier node identified by the first data (x₁).

The core enterprise node (C) determines a number from a large random number as the second data (x₂), and ×2∈(1, n).

The core enterprise (C) generates the symmetric key of the first blockchain certificate corresponding to a first-level supplier node by using the computing session symmetric key function (KDF), and the expression of the symmetric key of the first blockchain certificate (K_{S}_{₁}_{C}) is:

K_{S}_{₁}_{C}=KDF((g^{x}^{₁})^{x}^{₂}).

In the above formula, K_{S}_{₁}_{C} is the symmetric key of the first blockchain certificate, KDF is the symmetric key function, and (g^{x}^{₁})^{x}^{₂} is the primitive root information corresponding to the first data and the second data.

Then, the core enterprise node (C) calculates the first pseudo-anonymous identifier and its expression is:

$${P}_{{S}_{1}} = {MAC}_{{K}_{{S}_{1} C}} ( 𝔸 )$$

[symbol]

={ID_{S}_{₁},PK_{S}_{₁},@S₁}

In the above formula, P_{S}_{₁} is the first pseudo-anonymous identifier, MAC is message authentication code, K_{S}_{₁}_{C} is the symmetric key of the first blockchain certificate of the first-level supplier node, A is the identity information of the first-level supplier node, ID_{S}_{₁} is the public key of the first-level supplier node, @S₁ is the blockchain address of the first-level supplier node.

The core enterprise (C) exposes the first pseudo-anonymous identifier through its Web services.

(S13) The first-level supplier node responds to the service exposure of the first pseudo-anonymous identifier from the core enterprise node, and generates a first multivariate array corresponding to the first-level supplier node based on the first pseudo-anonymous identifier.

In the step (S13), the expression of the first multivariate array is (P_{S}_{₁}, x₁, [symbol] ). Among them, P_{S}_{₁} is the first pseudo-anonymous identifier, x₁ is the first data, and [symbol] is the identity information of the first-level supplier node.

(S14) The first-level supplier node generates the first blockchain certificate of the first-level supplier node based on the first multivariate array and a timestamp at a current moment.

In the step (S14), the expression of the first blockchain certificate corresponding to the first-level supplier node is:

[symbol]

_{S}_{₁}=(P_{S}_{₁},x₁, [symbol] ,T_{S}_{₁}).

In the above formula, [symbol] _{S}_{₁} is the first blockchain certificate corresponding to the first-level supplier node, P_{S}_{₁} is the first pseudo-anonymous identifier, x₁ is the first data, [symbol] is the identity information of the first-level supplier node, T_{S}_{₁} is the timestamp of the current time.

The verification of the first blockchain certificate can be obtained by comparing a new first pseudo-anonymous identifier with the previous one (P_{S}_{₁}). The new first pseudo-anonymous identifier is recalculated using the first multidimensional array.

In addition, T_{S}_{₁} is the timestamp of the current time. T_{S}_{₁} can also be the timestamp of the deadline, and the first blockchain certificate will be revoked if outdated. Unlike conventional certificates, the first blockchain certificates of the present disclosure do not require digital signatures. Furthermore, the first blockchain certificates of the present disclosure are private, meaning that they are only exchanged between the intended parties.

Similarly, the factoring node (F) and other supplier (S_{N}) nodes can obtain the first blockchain certificates according to their specific need.

The step (S1) describes the way of generating user identity. Utilizing the blockchain, the first blockchain certificate is created, guaranteeing the accuracy and integrity of its content and features security, uniqueness and convenience. The first blockchain certificate contains the user identity detail, serving as a detail ID card. During network communication, the first blockchain certificate enables the confirmation of the user identity and supports the querying and encryption of transmission data.

(S2) The blockchain certificates are sent to a core enterprise node, and the blockchain certificates are configured to trigger the core enterprise node to confirm user identities of the multi-level supplier nodes.

In the step (S2), the core enterprise node performs confirming the related certificates based on the invoked preset smart contract for the confirmation of the user identities.

(S3) After receiving a confirmation feedback of the user identities of the multi-level supplier nodes sent from the core enterprise node, a first-level supplier node among the multi-level supplier nodes sends a request for a completed work item to the core enterprise node.

In the step (S3), the request for the completed work item includes the work item accounts receivable of the first-level supplier node and the completed work item data of the first-level supplier node.

The completed work item data may be uploaded to the system in the form of videos or pictures, including completed work item basic information, textual information, and transaction document video information. The completed work item basic information includes contract number, contract start date, names of goods or services, payer, payment account, payment amount, payment currency, payee, payee account, amount of the completed work item, time of the completed work item, etc. The textual information includes goods information, payment remark, and payment appointment; and the transaction document video information includes at least one contract video and at least one invoice video.

The work item accounts receivable generated by the completed work item data based on real basic contracts has direct constraints on both creditors and debtors, which is legally reasonable in its expectancy and relative certainty. Furthermore, with certain commercial value, the completed work item data will generate a certain income in the future. Based on this, the factoring node can provide the factoring financing service to the suppliers. Additionally, due to the veracity of the completed work item data (such as transaction contracts, transaction forms, and transaction data), the financial stability, and the superior debt repayment capacity of the core enterprise node, the accounts receivable is transferable.

(S4): A completed work item of the first-level supplier node is obtained, and a completed work item digital bill of the first-level supplier node is generated based on a preset smart contract and the completed work item of the first-level supplier node.

The step (S4) includes the following sub-steps (S41)-(S44).

(S41): The first-level supplier node randomly generates a third data.

Specifically, the first-level supplier node is the first-level supplier node (S₁) and determines a number from a large random number as the third data (a₁), and a₁∈(1, n).

(S42): A signature information is generated based on the third data, the blockchain certificate of the first-level supplier node and the completed work item of the first-level supplier node. And the signature information is configured to trigger the core enterprise node to perform attribute information verification for the completed work item of the first-level supplier node, and a result of the attribute information verification is configured to trigger the core enterprise node to calculate a second pseudo-anonymous identifier and perform service exposure for the second pseudo-anonymous identifier, and the fourth data is randomly generated by the core enterprise node.

In the step (S42), the expression for the signature information is:

m=( [symbol] _{S}_{_{1,WI,}}g^{a}^{₁}).

In the above formula, m is the signature information, [symbol] _{S}_{₁} is the first blockchain certificate corresponding to the first-level supplier node, WI is the completed work item of the first-level supplier node, g^{a}^{₁} is the primitive root information of the first-level supplier node identified by the third data.

Responsive to receiving the signature information, the core enterprise node performs attribute information verification for the completed work item of the first-level supplier node, specifically confirming whether the completed work item of the completed work item of the first-level supplier node has been released. If not, the core enterprise node performs verifying the signature information.

The core enterprise node (C) determines a number from a large random number as the fourth data (a₂), and a₂∈(1, n).

In the step (S42), the expression of the second pseudo-anonymous identifier is:

$${P}_{WI} = {MAC}_{{K}_{{S}_{1} C}^{′}} ( {𝒞}_{{S}_{1}} , WI , {a}_{WI} , {d}_{WI} )$$

$${K}_{{S}_{1} C}^{′} = KDF ( {( {g}^{{a}_{1}} )}^{{a}_{2}} ) .$$

In the above formula, P_{WI} is the second pseudo-anonymous identifier, MAC is message authentication code, K′_{S}_{₁}_{C} is the symmetric key of the signature information, KDF is the symmetric key function, (g^{a}^{₁})^{a}^{₂} is the primitive root information corresponding to the third data and the fourth data, [symbol] _{S}_{₁} is the first blockchain certificate corresponding to the first-level supplier node, WI is the completed work item of the first-level supplier node, a_{WI} is the amount of the completed work item, and d_{WI} is the deadline corresponding to the completed work item.

The core enterprise node (C) exposes the second pseudo-anonymous identifier through its Web service.

(S43): In respond to the service exposure of the second pseudo-anonymous identifier from the core enterprise node, the first-level supplier node generates a second multivariate array corresponding to the first-level supplier node based on the second pseudo-anonymous identifier, the third data and the fourth data.

In the step (S43), the expression of the second multivariate array is (P_{WI}, a₁, g^{a}^{₂}), and P_{WI} is the second pseudo-anonymous identifier, a₁ is the third data, g^{a}^{₂} is the primitive root information corresponding to the fourth data.

(S44): The completed work item digital bill of the first-level supplier node is generated based on the preset smart contract and the second multivariate array.

In the step (S44), the expression of the completed work item digital bill of the first-level supplier node is:

[symbol]

_{WI}=(P_{WI},a₁,WI, [symbol] _{S}_{₁},a_{WI},d_{WI},T_{WI},f,@ [symbol] _{WI}).

In the above formula, [symbol] _{WI} is the completed work item digital bill of the first-level supplier node, P_{WI} is the second pseudo-anonymous identifier, a₁ is the third data, WI is the completed work item of the first-level supplier node, [symbol] _{S}_{₁} is the first blockchain certificate corresponding to the first-level supplier node, T_{WI} is the timestamp generated by the completed work item digital bill of the first-level supplier node, f is the transfer identifier of the completed work item digital bill, and @ [symbol] _{WI} is the blockchain address of the preset smart contract, when f=1, the completed work item digital bill is allowed to be transferred, otherwise, it is prohibited to be transferred.

In practical applications, multi-level suppliers can issue the completed work item digital bill for circulation and offsetting to activate receivables, dissolve debts, and reduce litigation.

Once generated, the completed work item digital bill is written in the blockchain. Characterized by its uniqueness, transparency, immutability, and verifiability, the completed work item digital bill of the present disclosure provides verifiable and authentic digital evidence for subsequent suppliers in a series of financing based on the completed work item digital bill.

In the present disclosure, (1) the core enterprise node does not need to perform a digital signature, and only needs to perform a one-time small calculation on each completed work item digital bill; (2) the first-level supplier node performs identity verification on Web service (the core enterprise node) before sending the request for the completed work item, and its connection is protected by HTTPS, thus safeguarding its privacy. (3) to better protect privacy, only one MAC and two public DH values can be released.

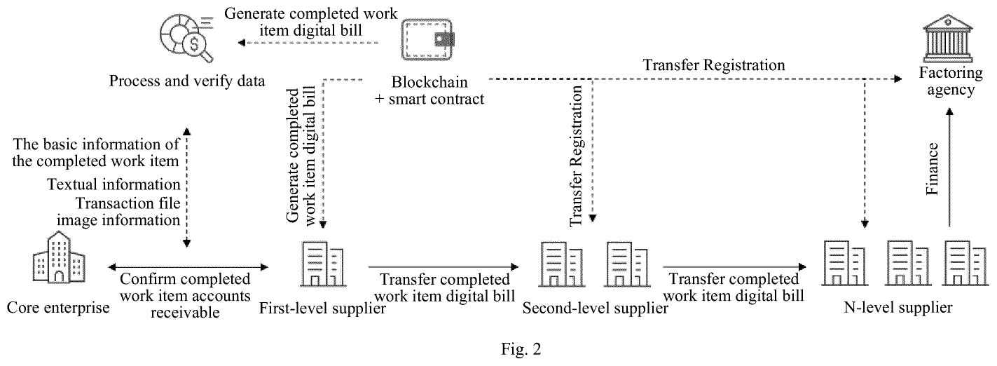

A completed work item digital bill transfer is shown in FIG. 2. After obtaining the verifiable completed work item digital bill confirmed by the core enterprise node, the first-level supplier node transfers the completed work item digital bill to other supplier nodes, banks for discounting, or depository institutions. The transfer of the completed work item digital bill can solve the suppliers' capital shortage and expand the scale of companies.

(S5) One or more transfers among the multi-level supplier nodes according to the completed work item digital bill is performed, and credit transfer digital certificates respectively corresponding to different levels of the multi-level supplier nodes is generated based on the preset smart contract during a transfer process.

In the step (S5), during one transfer, it includes the step (S51) which furthers includes sub-steps S511-S518.

(S511) A second-level supplier node among the multi-level supplier nodes randomly generates a fifth data, and the first-level supplier node randomly generates a seventh data.

The second-level supplier node (S2) determines a number from a large random number as the fifth data (k₂), and k₂∈(1, n).

The first-level supplier node (S₁) determines a number from a large random number as the seventh data (l₁), and; l₁∈(1, n).

(S512) The second-level supplier node encrypts an account information of a second-level supplier based on the fifth data to obtain an encrypted account information of the second-level supplier.

In the step (S512), the expression of the account information of the second-level supplier node is (BAN_{S}_{₂}). Utilizing the symmetric key function (KDF), the second-level supplier node and the core enterprise node generate the symmetric key of the account of the second-level supplier node (K_{S}_{₂}_{C}) for encryption to obtain the encrypted account information of the second-level supplier. This allows the second-level supplier node to safely withdraw the account from the core enterprise node.

(S513): The completed work item digital bill and an account information of the first-level supplier node are sent to the second-level supplier node.

In the step (S513), the expression of the account information of the first-level supplier node is BAN_{S}_{₁}.

(S514): The second-level supplier node verifies the completed work item digital bill and the account information of the first-level supplier node.

In the step (S514), the second-level supplier node verifies the completed work item digital bill and the account information of the first-level supplier node based on the invoked preset smart contract.

(S515): When the completed work item digital bill and the account information of the first-level supplier node are verified to be correct, the second-level supplier node obtains a content information of the completed work item digital bill.

In the step (S515), the content information of the completed work item digital bill includes the address of the preset smart contract, which is used for the second-level supplier node to verify and determine whether the completed work item digital bill has been transferred. If not, the subsequent process will be carried out.

(S516): The second-level supplier node generates a protocol data based on the encrypted account information of the second-level supplier and the content information of the completed work item digital bill and sends the protocol data to the first-level supplier node.

In the step (516), the expression of the protocol data is:

$${𝒜}_{{S}_{1} {S}_{2}} = ( {𝒞}_{W I} , {𝒞}_{{S}_{2}} , {a}_{W I} , {d}_{W I} , {T}_{{𝒜}_{{S}_{1} {S}_{2}}} , BA {N}_{{S}_{1}} ) .$$

In the above formula, [symbol] _{S}_{₁}_{S}_{₂} is the protocol data, [symbol] _{WI} is the completed work item digital bill of the first-level supplier node, [symbol] _{S}_{₂} is the first blockchain certificate corresponding to the second-level supplier node, a_{WI} is the amount of the completed work item, d_{WI} is the deadline corresponding to the completed work item,

$${T}_{{𝒜}_{{S}_{1} {S}_{2}}}$$

is the timestamp generated by the protocol data, and BAN_{S}_{₁} is the account information of the first-level supplier node.

(S517) The first-level supplier node verifies content of the protocol data, and when a verification of the protocol data is passed, the first-level supplier node generates a first-level transfer notification based on the seventh data, and sends the first-level transfer notification to the core enterprise node, And the first-level transfer notification is configured to trigger the core enterprise node to generate a first-level credit transfer digital notification based on a sixth data, and the sixth data is randomly generated by the core enterprise node.

In the step (S517), the expression of the first-level transfer notification is:

m₁=( [symbol] _{S}_{₁}, [symbol] _{S}_{₁}_{S}_{₂},CRTA,a_{WI},d_{WI},g^{l}^{₁})

In the above formula, m₁ is the first-level transfer notification, [symbol] _{S}_{₁} is the first blockchain certificate corresponding to the first-level supplier node, [symbol] _{S}_{₁}_{S}_{₂} is the protocol data, CRTA is the credit transfer digital protocol, a_{WI} is the amount of the completed work item, d_{WI} is the deadline corresponding to the completed work item, and g^{l}^{₁} is the primitive information corresponding to the seventh data.

The core enterprise node (C) determines whether the completed work item digital bill has been transferred. If not, the core enterprise node (C) verifies the signature information. The core enterprise node (C) determines a number from a large random number as the sixth data (l₂), and l₂∈(1, n).

In the step (517), the expression of the first-level credit transfer digital notification is:

$${𝒩}_{{𝒞}_{WI}} = ( {P}_{{𝒞}_{WI}}^{1} , {l}_{1} , {𝒞}_{{S}_{1}} , {𝒞}_{WI} , CRTA , h ( CRTA ) , {T}_{{𝒩}_{{𝒞}_{WI}}} , @ {𝒩}_{{𝒞}_{WI}} ) ;$$

$${P}_{{𝒞}_{WI}}^{1} = {MAC}_{{K}_{{S}_{1} C}^{″}} ( {𝒞}_{{S}_{1}} , {𝒞}_{WI} , @ {𝒞}_{WI} ) ;$$

$${K}_{{S}_{1} C}^{″} = KDF ( {( {g}^{{l}_{1}} )}^{{l}_{2}} ) .$$

In the above formula, [symbol] is the first-level credit transfer digital notification, [symbol] is the second pseudo-anonymous identifier of the completed work item digital bill, l₁ is the seventh data, [symbol] _{S}_{₁} is the first blockchain certificate corresponding to the first-level supplier node, [symbol] _{WI} is the completed work item digital bill of the first-level supplier node, CRTA is the credit transfer digital protocol, h(CRTA) is the information of the credit transfer digital protocol, [symbol] is the timestamp corresponding to the first-level credit transfer digital notification, @ [symbol] is the blockchain address of the preset smart contract of the first-level credit transfer digital notification, MAC is the message authentication code, K″_{S}_{₁}_{C} the symmetric key corresponding to the first-level transfer notification, @ [symbol] _{WI} is the blockchain address of the preset smart contract, KDF is the symmetric key function, and (g^{l}^{₁})^{l}^{₂} is the primitive information corresponding to the sixth data and the seventh data.

(S518): After receiving the first-level credit transfer digital notification, the first-level supplier node verifies the first-level credit transfer digital notification. When the first-level credit transfer digital notification is verified to be valid, the first-level supplier node sends a first-level credit transfer information to the second-level supplier node, and the second-level supplier node generates a first-level credit transfer digital certificate based on the first-level credit transfer information.

In the step (518), the expression of the first-level credit transfer digital certificate is:

$$DCCT = ( CRTA , {𝒩}_{{𝒞}_{WI}} , {\{ CRTA , {𝒩}_{{𝒞}_{WI}} \}}_{S {K}_{{S}_{2}}} , {T}_{D C C T} )$$

In the above formula, DCCT is the first-level credit transfer digital certificate, CRTA is the credit transfer digital protocol, [symbol] is the first-level credit transfer digital notification,

$${\{ CRTA , {𝒩}_{{𝒞}_{WI}} \}}_{S {K}_{{S}_{2}}}$$

is the credit transfer digital protocol and the first-level credit transfer digital notification that is encrypted by the second-level node by using the private key thereof, and T_{DCCT} is the timestamp corresponding to the first-level credit transfer digital certificate.

In the step (S5), during more transfers, it includes the step (S52) which furthers includes sub-steps S521-S528.

(S521) An N+1th-level supplier node randomly generates an eighth data and an N^{th}-level supplier node randomly generates a tenth data.

The N+1^{th}-level supplier node (S_{N+1}) determines a number from a large random number as the eighth data (k₂^{(N)}), and k₂^{(N)}∈(1, n).

The N^{th}-level supplier node (S_{N}) determines a number from a large random number as the tenth data (l₁^{(N)}, and l₁^{(N)}∈(1, n).

(S522) The N+1^{th}-level supplier node encrypts an account information of the N+1^{th}-level supplier based on the eighth data to obtain an encrypted account information of the N+1^{th}-level supplier.

In the step (S522), the account information of the N+1^{th}-level supplier is expressed as (BAN_{S}_{_{N+1}}). Utilizing the symmetric key function (KDF), the N+1^{th}-level supplier node and the core enterprise node generate the symmetric key of the account of the N+1^{th}-level supplier (K_{S}_{_{N+1}}_{C}) for encryption to obtain the encrypted account information of the N+1^{th}-level supplier. This allows the N+1^{th}-level supplier node to safely receive the account from the core enterprise node.

(S523) The completed work item digital bill and an account information of the N^{th}-level supplier are sent to the N+1^{th}-level supplier node.

In the step (S523), the expression of the account information of the N^{th}-level supplier node is BAN_{S}_{_{N}}.

(S524) The N+1^{th}-level supplier node verifies the completed work item digital bill and the N−1^{th}-level credit transfer digital certificate.

In the step (S524), the N+1^{th}-level supplier node verifies the completed work item digital bill and the N−1^{th}-level credit transfer digital certificate based on the invoked preset smart contract.

(S525) When the completed work item digital bill and the N−1^{th}-level credit transfer digital certificate are verified to be correct, the N+1^{th}-level supplier node obtains a content information of the completed work item digital bill.

In the step (S525), the content information of the completed work item digital bill includes the address of the preset smart contract, which is used for the N+1^{th}-level supplier node to verify and determine whether the completed work item digital bill has been transferred, and if not, the subsequent process will be carried out.

(S526) The N+1^{th}-level supplier node generates an N^{th}-level protocol data based on the encrypted account information of the N+1^{th}-level supplier and the content information of the completed work item digital bill and sends the N^{th}-level protocol data to the N^{th}-level supplier node.

In the step (526), the expression of the N^{th}-level protocol data is:

$${𝒜}_{{S}_{N} {S}_{N + 1}} = ( {𝒞}_{W I} , {𝒞}_{{S}_{N + 1}} , {a}_{W I} , {d}_{W I} , {T}_{{𝒜}_{{S}_{N} {S}_{N + 1}}} , BA {N}_{{S}_{N}} ) .$$

In the above formula, [symbol] _{S}_{_{N}}_{S}_{_{N+1}} is the N^{th}-level protocol data, [symbol] _{WI} is the completed work item digital bill of the first-level supplier node, [symbol] _{S}_{_{N+1}} is the first blockchain certificate corresponding to the N+1^{th}-level supplier node, a_{WI} is the amount of the completed work item, d_{WI} is the deadline corresponding to the completed work item,

$${T}_{{𝒜}_{{S}_{N} {S}_{N + 1}}}$$

is the timestamp generated by the N^{th}-level protocol data, and BAN_{S}_{_{N}} is the account information of the N^{th}-level supplier node.

(S527) The N^{th}-level supplier node verifies content of the N^{th}-level protocol data, and when a verification of the N^{th}-level protocol data is passed, the N^{th}-level supplier node generates an N^{th}-level transfer notification based on the tenth data, and sends the N^{th}-level transfer notification to the core enterprise node, and the N^{th}-level transfer notification is configured to trigger the core enterprise node to generate an N^{th}-level credit transfer digital notification based on a ninth data, and the ninth data is randomly generated by the core enterprise node.

In the step (S527), the expression of the N^{th}-level transfer notification is:

m_{N}=( [symbol] _{S}_{_{N}}, [symbol] _{S}_{_{N}}_{S}_{_{N+1}},CRTA^{(N)},a_{WI},d_{WI},g^{l}^{₁}^{^{(N)}}).

In the above formula, m_{N} is the N^{th}-level transfer notification, [symbol] _{S}_{_{N}} is the first blockchain certificate corresponding to the N^{th}-level supplier node, [symbol] _{S}_{_{N}}_{S}_{_{N+1}} is the N^{th}-level protocol data, CRTA^{(N)} is the N^{th}-level credit transfer digital protocol, a_{WI} is the amount of the completed work item, d_{WI} is the deadline corresponding to the completed work item, and g^{l}^{₁}^{^{(N)}} is the primitive information corresponding to the tenth data.

The core enterprise node (C) determines whether the completed work item digital bill has been transferred. If not, the core enterprise node (C) verifies the signature information. The core enterprise node (C) determines a number from a large random number as the ninth data (l₂^{(N)}), and l₂^{(N)}∈(1, n).

In the step (527), the expression of the N^{th}-level credit transfer digital notification is:

$${𝒩}_{{𝒞}_{W I}}^{( N )} = ( {P}_{{𝒞}_{W I}}^{( N )} , {l}_{1}^{( N )} , {𝒞}_{{S}_{N}} , {𝒞}_{W I} , CRT {A}^{( N )} , h ( C R T {A}^{( N )} ) , {T}_{{𝒩}_{{𝒞}_{WI}}^{( N )}} , @ {𝒩}_{{𝒞}_{W I}}^{( N )} ) ;$$

$${P}_{{𝒞}_{W I}}^{( N )} = M A {C}_{{K}_{{S}_{N} C}^{″}} ( {𝒞}_{{S}_{N}} , {𝒞}_{W I} , @ {𝒞}_{W I} ) ;$$

$${K}_{SNC}^{″} = KDF ( {( {g}^{{l}_{1}^{( N )}} )}^{{l}_{2}^{( N )}} .$$

In the above formula, [symbol] is the N^{th}-level credit transfer digital notification, [symbol] is the N^{th}-level second pseudo-anonymous identifier of the completed work item digital bill, l₁^{(N)} is the tenth data, [symbol] _{S}_{_{N}} is the first blockchain certificate corresponding to the N^{th}-level supplier node, [symbol] _{WI} is the completed work item digital bill of the N^{th}-level supplier node, CRTA^{(N)} is the N^{th}-level credit transfer digital protocol, h(CRTA^{(N)}) is the information of the N^{th}-level credit transfer digital protocol,

$${T}_{{𝒩}_{{𝒞}_{W I}}^{( N )}}$$

is the timestamp corresponding to the N^{th}-level credit transfer digital notification, @ [symbol] is the blockchain address of the preset smart contract of the N^{th}-level credit transfer digital notification, MAC is the message authentication code, K″_{S}_{_{N}}_{C} the symmetric key corresponding to the N^{th}-level transfer notification, @ [symbol] _{WI} is the blockchain address of the preset smart contract, KDF is the symmetric key function, and (g^{l}^{₁}^{^{(N)}})^{l}^{₂}^{^{(N)}} is the primitive information corresponding to the ninth data and the tenth data.

The N^{th}-level credit transfer digital notification is generated by the interaction between the N-level supplier node and the core enterprise node, that is, both of them agree on the rationality and authenticity of debt transfer, so the credit transfer will be legally effective.

(S528) After receiving the N^{th}-level credit transfer digital notification, the N^{th}-level supplier node verifies the N^{th}-level credit transfer digital notification. When the N^{th}-level credit transfer digital notification is verified to be valid, the N^{th}-level supplier node sends an N^{th}-level credit transfer information to the N+1^{th}-level supplier node, and the N+1^{th}-level supplier node generates an N^{th}-level credit transfer digital certificate based on the first-level credit transfer information.

In the step (528), the expression of the N^{th}-level credit transfer digital certificate is:

$${DCCT}^{( N )} = ( C R T {A}^{( N )} , {𝒩}_{{𝒞}_{W I}}^{( N )} , {\{ CRT {A}^{( N )} , {𝒩}_{{𝒞}_{W I}}^{( N )} \}}_{S {K}_{{S}_{N + 1}}} , {T}_{D C C {T}^{( N )}} ) .$$

In the above formula, DCCT^{(N)} is the N^{th}-level credit transfer digital certificate, CRTA^{(N)} is the N^{th}-level credit transfer digital protocol, [symbol] is the N^{th}-level credit transfer digital notification,

$${\{ {CRTA}^{( N )} , {𝒩}_{{𝒞}_{WI}}^{( N )} \}}_{S {K}_{{S}_{N + 1}}}$$

is the N-level credit transfer digital protocol and the N^{th}-level credit transfer digital notification that is encrypted by the N+1^{th}-level node by using the private key thereof, and T_{DCCT}(N) is the timestamp corresponding to the N^{th}-level credit transfer digital certificate.

The N^{th}-level credit transfer digital certificate (DCCT^{(N)}) includes the signatures from the N^{th}-level supplier node and the N+1^{th}-level supplier node, which have obtained clear approval from both parties. DCCT^{(N)} has also been verified and confirmed by the core enterprise node. So, N transfers of the completed work item digital bill have been completed.

In the present disclosure, the timestamp of N transfers of the completed work item digital bill should satisfy the following relationship:

$${T}_{C R T {A}^{( N - 1 )}} < {T}_{C R T {A}^{( N )}}$$

$${T}_{{𝒜}_{{S}_{N - 1} {S}_{N}}} < {T}_{{𝒜}_{{S}_{N} {S}_{N + 1}}}$$

$${T}_{{𝒩}_{{𝒞}_{S I}}^{( N - 1 )}} < {T}_{{𝒩}_{{𝒞}_{W I}}^{( N )}}$$

$${T}_{D C C {T}^{( N - 1 )}} < {T}_{D C C {T}^{( N )}} .$$

In the above formula, T_{CRTA}_{^{(N−1)}} is the timestamp corresponding to the N−1^{th}-level credit transfer digital protocol, T_{CRTA}_{^{(N)}} is the timestamp corresponding to the N^{th}-level credit transfer digital protocol,

$${T}_{{𝒜}_{{S}_{N - 1} {S}_{N}}}$$

is the timestamp corresponding to the N−1^{th}-level protocol data,

$${T}_{{𝒜}_{{S}_{N} {S}_{N + 1}}}$$

is the timestamp corresponding to the N^{th}-level protocol data,

$${T}_{{𝒩}_{{𝒞}_{W I}}^{( N - 1 )}}$$

is the timestamp corresponding to the N−1^{th}-level credit transfer digital notification,

$${T}_{{𝒩}_{{𝒞}_{W I}}^{( N )}}$$

is the timestamp corresponding to the N^{th}-level credit transfer digital notification, T_{DCCT}_{^{(N−1)}} is the timestamp corresponding to the N−1^{th}-level credit transfer digital certificate, and T_{DCCT}_{^{(N)}} is the timestamp corresponding to the N^{th}-level credit transfer digital certificate.

The timestamp of one transfer of the completed work item digital bill should satisfy the following relationship:

$${T}_{{𝒜}_{{S}_{N} {S}_{N + 1}}} < {T}_{C R T {A}^{( N )}} < {T}_{{𝒩}_{{𝒞}_{W I}}^{( N )}} < {T}_{D C C {T}^{( N )}} .$$

In the above formula,

$${T}_{{𝒜}_{{S}_{N} {S}_{N + 1}}}$$

is the timestamp corresponding to the N^{th}-level protocol data, T_{CRTA}_{^{(N)}} is the timestamp corresponding to the N^{th}-level credit transfer digital protocol,

$${T}_{{𝒩}_{{𝒞}_{W I}}^{( N )}}$$

is the timestamp corresponding to the N^{th}-level credit transfer digital notification, and T_{DCCT}_{^{(N)}} is the timestamp corresponding to the N^{th}-level credit transfer digital certificate.

It should be understood that if the timestamps do not satisfy the above relationships, it fails to complete the transfer.

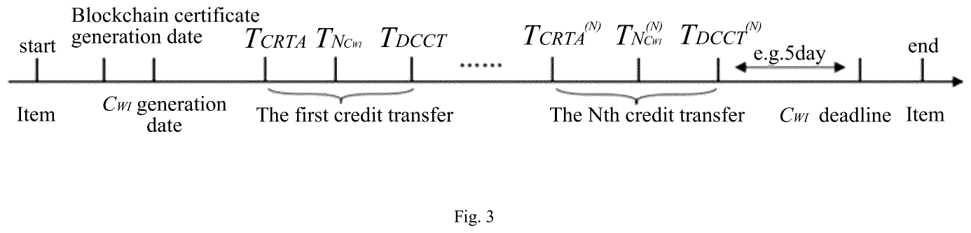

FIG. 3 shows the relationship between these timestamps. For example, the last transfer time should be made a certain period of time (e.g. 5 days) before the deadline of the completed work item digital bill to prevent the N-level suppliers node from delaying transfer for attempting to obtain the payment from the core enterprise node and the N+1-level supplier node. At the same time, it should be ensured that the entire transfer period falls within the project settlement time.

The preset smart contract is built on a public chain, where no one can intervene in the operation of smart contracts or alter any data related to the completed work item digital bill in the smart contract. To facilitate retrieval and save storage costs, the storage of information related to the completed work item digital bill is done in a Key-Value storage format. In this format, each data address is uniquely identified by a Key, while Value represents the actual stored content for that data.

In the step (S5), utilizing the preset smart contract, the credit transfer digital certificates corresponding to different levels of the multi-level supplier nodes are generated in the multiple transfers of the completed work item digital bill within the multi-level supplier nodes. The credit transfer digital certificates include the corresponding credit transfer digital protocols and the corresponding credit transfer digital notifications. Due to multiple times transfers and complicated work item data, for the convenience of retrieval and query by the core enterprise, other suppliers and factoring agencies, as well as for the core enterprise's receipt of payment, the step 5 includes step 53, which further includes sub-steps (S531)-(S533).

(S531): Based on the credit transfer digital protocol, a first index field is generated. Based on the first index field, mapping is performed with the first storage key-value of the smart contract, the first index field corresponds to the completed work item digital bill in the smart contract.

In the step (S531), the first index field is generated by the credit transfer digital protocol (CRTA) utilizing the log index in the smart contract.

(S532): Based on the credit transfer digital notification, a second index field is generated. Based on the second index field, mapping is performed with the second storage key-value of the smart contract, the second index field corresponds to the completed work item digital bill in the smart contract.

In the step (S532), the second index field is generated by the N^{th}-level credit transfer digital notification ( [symbol] ) utilizing the log index in the smart contract.

(S533): After the competition of the transfer of the completed work item digital bill, the first index field and the second index field are stored in the output transaction log of the smart contract.

In the smart contract, only when the first index field and the second index field are unique can the key values stored be mapped, which can prevent double transfer.

In the data transfer and circulation method of the present disclosure, the credit transfer digital protocols, the credit transfer digital notifications and the credit transfer digital certificates are all verifiable and tamper-proof. With the digital signatures and digital confirmations from different parties, they are authentically recorded in the blockchain system and can be retrieved through index for verification by demand sides (e.g. next-level suppliers or factoring agencies). Therefore, the certificates and the protocols of the present disclosure generated through security communication channels (e.g. HTTPS) and the smart contract can prevent tampering and cheating. Further, this approach simplifies the transfer process, enabling the transfer of the completed work item data on public chains, and positively impacts the development of the credit economy and financial markets.

(S6): The multi-level supplier nodes request factoring information from a factor node based on the credit transfer digital certificates.

In the step (S6), the multi-level supplier nodes apply factoring information corresponding to the credit transfer digital certificates from the factoring node, while the factoring node provides financing with a predetermined ratio based on the comprehensive enterprise situation of the multi-level supplier nodes.

In the data transfer and circulation method, taking the construction supply chain as an example for illustrative purposes, the core enterprise is exemplified as the construction unit, and the factoring company is exemplified as the financial institution. Multi-level suppliers apply for factoring financing services from financial institutions based on their own completed work item data (including transaction contracts, completed engineering-related forms, etc.). The completed work item can be obtained through the access of the construction site information system and other participating parties' information systems. For example, the Smart Construction Site integrated with multiple software and hardware builds a comprehensive real-time monitoring system for personnel management, intelligent tower crane monitoring system, mechanical management system, video surveillance system, deep foundation pit automation monitoring system, and AI intelligent warning management system, forming full-range real-time monitoring of the project's personnel, machinery, materials, methods, and environment, facilitating the uploading, collection, and monitoring of the work item data (such as photographed license plates at the front and rear of vehicles, identified material specifications, weights, etc.).

In the present disclosure, the Diffie-Hellma algorithm of cryptography may be used, and not limited to the Diffie-Hellma algorithm, but including elliptic curve cryptography (ECC algorithm), elliptic curve Diffie-Hellman algorithm (ECDH algorithm), and the like.

In addition, the DH values generated through the DH algorithm will be explicitly signed or transmitted through identity authentication to prevent counterfeiters or intermediaries from launching attacks on the authentication method described in the present disclosure.

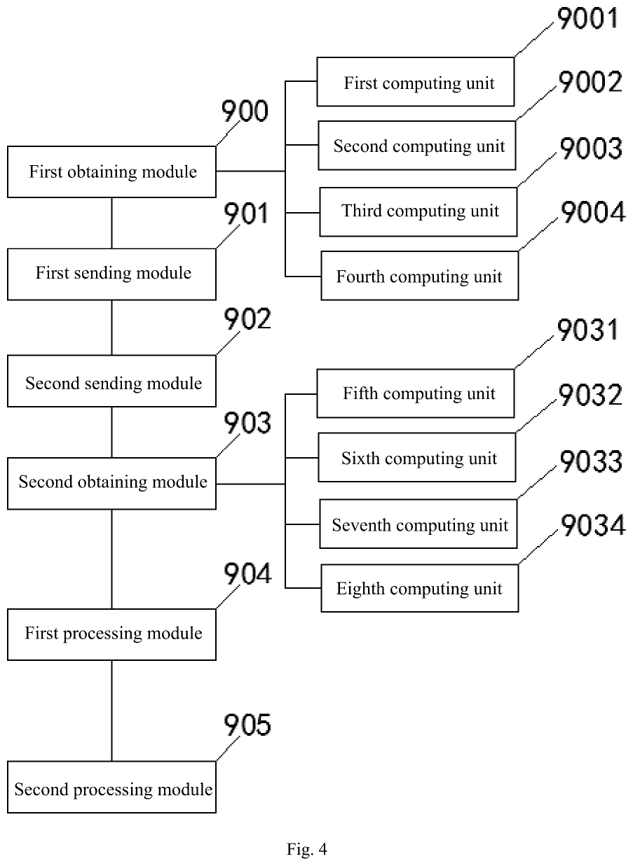

A data transfer and circulation device according to an embodiment of the present disclosure is shown in FIG. 4.

The data transfer and circulation device includes a first obtaining module 900, a first sending module 901, a second sending module 902, a second obtaining module 903, a first processing module 904 and a second processing module 905.

The first obtaining module 900 is configured for obtaining blockchain certificates respectively corresponding to multi-level supplier nodes.

The first sending module 901 is configured for sending the blockchain certificates to a core enterprise node, And the blockchain certificates are configured to trigger the core enterprise node to confirm user identities of the multi-level supplier nodes.

The second sending module 902 is configured for allowing a first-level supplier node among the multi-level supplier nodes to send a request for a completed work item to the core enterprise node after receiving a confirmation feedback of the user identities of the multi-level supplier nodes sent from the core enterprise node.

The second obtaining module 903 is configured for obtaining a completed work item of the first-level supplier node, and generating a completed work item digital bill of the first-level supplier node based on a preset smart contract and the completed work item of the first-level supplier node.

The first processing module 904 is configured for performing one or more transfers among the multi-level supplier nodes according to the completed work item digital bill, and generating credit transfer digital certificates respectively corresponding to different levels of the multi-level supplier nodes based on the preset smart contract during a transfer process.

The second processing module 905 is configured for allowing the multi-level supplier nodes to request factoring information from a factor node based on the credit transfer digital certificates.

Further, the first obtaining module 900 according to an embodiment of the present disclosure includes a first computing unit 9001, a second computing unit 9002, a third computing unit 9003 and a fourth computing unit 9004.

The first computing unit 9001 is configured for allowing the first-level supplier node to randomly generate a first data.

The second computing unit 9002 is configured for determining a primitive root information of the first-level supplier node based on the first data, and sending the primitive root information to the core enterprise node, And the primitive root information is configured to trigger the core enterprise node to calculate a first pseudo-anonymous identifier based on a second data and perform service exposure for the first pseudo-anonymous identifier, and the second data is configured to be randomly generated by the core enterprise node.

The third computing unit 9003 is configured for, in response to the service exposure of the first pseudo-anonymous identifier, allowing the first-level supplier node to generate a first multivariate array corresponding to the first-level supplier node based on the first pseudo-anonymous identifier.

The fourth computing unit 9004 is configured for allowing the first-level supplier node to generate a blockchain certificate of the first-level supplier node based on the first multivariate array and a timestamp at a current moment.

Further, the second obtaining module 903 according to an embodiment of the present disclosure includes a fifth computing unit 9031, a sixth computing unit 9032, a seventh computing unit 9033 and an eighth computing unit 9034.

The fifth computing unit 9031 is configured for allowing the first-level supplier node to randomly generate a third data.

The sixth computing unit 9032 is configured for generating a signature information based on the third data, the blockchain certificate of the first-level supplier node and the completed work item of the first-level supplier node. And the signature information is configured to trigger the core enterprise node to perform attribute information verification for the completed work item of the first-level supplier node, and a result of the attribute information verification is configured to trigger the core enterprise node to calculate a second pseudo-anonymous identifier based on a fourth data and perform service exposure for the second pseudo-anonymous identifier; and the fourth data is configured to be randomly generated by the core enterprise node.

The seventh computing unit 9033 is configured for, in response to the service exposure of the second pseudo-anonymous identifier, allowing the first-level supplier node to generate a second multivariate array corresponding to the first-level supplier node based on the second pseudo-anonymous identifier, the third data and the fourth data.

The eighth computing unit 9034 is configured for generating the completed work item digital bill of the first-level supplier node based on the preset smart contract and the second multivariate array.

Further, the first processing module 904 according to an embodiment of the present disclosure includes a first transfer module 9041 and the first transfer module 9041 includes a first processing unit 90411, a first encryption unit 90412, a first sending unit 90413, a first verification unit 90414, a second processing unit 90415, a third processing unit 90416, a fourth processing unit 90417 and a fifth processing unit 90418.

The first processing unit 90411 is configured for allowing a second-level supplier node among the multi-level supplier nodes to randomly generate a first data, and allowing the first-level supplier node to randomly generate a second data.

The first encryption unit 90412 is configured for allowing the second-level supplier node to encrypt an account information of the second-level supplier node based on the first data to obtain an encrypted account information of the second-level supplier node.

The first sending unit 90413 is configured for sending the completed work item digital bill and an account information of the first-level supplier node to the second-level supplier node.

The first verification unit 90414 is configured for allowing the second-level supplier node to verify the completed work item digital bill and the blockchain certificate of the first-level supplier node.

The second processing unit 90415 is configured for allowing the second-level supplier node to obtain a content information of the completed work item digital bill when the completed work item digital bill and the account information of the first-level supplier node are verified to be correct.

The third processing unit 90416 is configured for allowing the second-level supplier node to generate a protocol data based on the encrypted account information of the second-level supplier node and the content information of the completed work item digital bill, and sending the protocol data to the first-level supplier node.

The fourth processing unit 90417 is configured for allowing the first-level supplier node to verify content of the protocol data, and when a verification of the protocol data is passed, generating a first-level transfer notification based on the second data, and sending the first-level transfer notification to the core enterprise node. And the first-level transfer notification is configured to trigger the core enterprise node to generate a first-level credit transfer digital notification based on a third data, and the third data is configured to be randomly generated by the core enterprise node.

The fifth processing unit 90418 is configured for, after receiving the first-level credit transfer digital notification, allowing the first-level supplier node to verify the first-level credit transfer digital notification, allowing the first-level supplier node to send a first-level credit transfer information to the second-level supplier node when the first-level credit transfer digital notification is verified to be valid, the second-level supplier node generating a first-level credit transfer digital certificate based on the first-level credit transfer information.

Further, the first processing module 904 according to an embodiment of the present disclosure includes a second transfer module 9042 and the second transfer module 9042 includes a sixth processing unit 90421, a second encryption unit 90422, a second sending unit 90423, a second verification unit 90424, a seventh processing unit 90425, an eighth processing unit 90426, a ninth processing unit 90427 and a tenth processing unit 90428.

The sixth processing unit 90421 is configured for allowing an N+1^{th}-level supplier node among the multi-level supplier nodes to randomly generate an eighth data, and allowing an N^{th}-level supplier node among the multi-level supplier nodes to randomly generate a tenth data.

The second encryption unit 90422 is configured for allowing the N+1^{th}-level supplier node to encrypt an account information of the N+1^{th}-level supplier based on the eighth data to obtain an encrypted account information of the N+1^{th}-level supplier.

The second sending unit 90423 is configured for sending the completed work item digital bill and an account information of the first-level supplier node to the second-level supplier node.

The second verification unit 90424 is configured for allowing the N+1^{th}-level supplier node to verify the completed work item digital bill and the blockchain certificate of the N^{th}-level supplier node.

The seventh processing unit 90425 is configured for allowing the N+1^{th}-level supplier node to obtain a content information of the completed work item digital bill when the completed work item digital bill and the account information of the N^{th}-level supplier node are verified to be correct.

The eighth processing unit 90426 is configured for allowing the N+1^{th}-level supplier node to generate an N^{th}-level protocol data based on the encrypted account information of the N+1^{th}-level supplier and the content information of the completed work item digital bill, and sending the N^{th}-level protocol data to the N^{th}-level supplier node.

The ninth processing unit 90427 is configured for allowing the N^{th}-level supplier node to verify content of the N^{th}-level protocol data, and when a verification of the N^{th}-level protocol data is passed, generating an N^{th}-level transfer notification based on the tenth data, and sending the N^{th}-level transfer notification to the core enterprise node. The N^{th}-level transfer notification is configured to trigger the core enterprise node to generate an N^{th}-level credit transfer digital notification based on a ninth data, and the ninth data is configured to be randomly generated by the core enterprise node.

The tenth processing unit 90428 is configured for, after receiving the N^{th}-level credit transfer digital notification, allowing N^{th}-level supplier node to verify the N^{th}-level credit transfer digital notification, allowing the N^{th}-level supplier node to send an N^{th}-level credit transfer information to the N+1^{th}-level supplier node when the N^{th}-level credit transfer digital notification is verified to be valid, N+1^{th}-level supplier node generating an N^{th}-level credit transfer digital certificate based on the N^{th}-level credit transfer information.

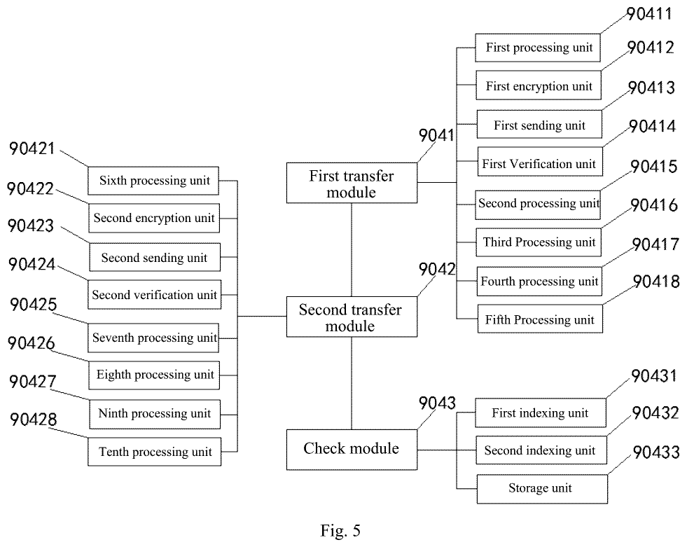

Further, the first processing module 904 according to an embodiment of the present disclosure shown in FIG. 5 includes a check module 9043, and the check module 9043 includes a first indexing unit 90431, a second indexing unit 90432 and a storage unit 90433.

The first indexing unit 90431 is configured for generating a first index field based on the credit transfer digital protocol. The first indexing unit 90431 is also configured for mapping with the first storage key-value of the smart contract and the first index field. The first index field corresponds to the completed work item digital bill in the smart contract.

The second indexing unit 90432 is configured for generating a second index field based on the credit transfer digital notification. The first indexing unit 90432 is also configured for mapping with the second storage key-value of the smart contract and the second index field. The second index field corresponds to the completed work item digital bill in the smart contract.

The storage unit 90433 is configured for storing the first index field and the second index field in the output transaction log of the smart contract, after the competition of the transfer of the completed work item digital bill.

In correspondence to the embodiments mentioned above, another embodiment provides a data transfer and circulation device. The data transfer and circulation device described below corresponds to the data transfer and circulation method described above, and they can be mutually referenced accordingly.

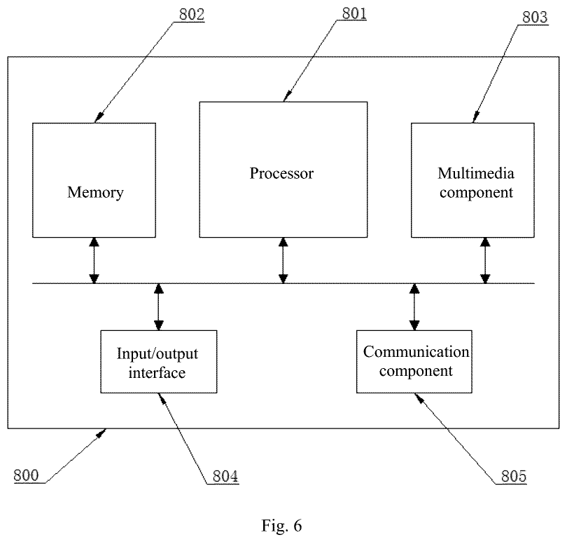

FIG. 6 depicts a block diagram of a data transfer and circulation system 800 according to an exemplary embodiment. The data transfer and circulation system 800 may include a processor 801 and a memory 802. The data transfer and circulation system 800 may further include one or more multimedia components 803, an I/O interface 804, and a communication component 805.

The processor 801 is configured for controlling the overall operation of the data transfer and circulation system 800 to complete all or part of the steps of the data transfer and circulation method described above. The memory 902 is configured for storing various types of data to support the operation of the data transfer and circulation system 800. The data may include instructions for any applications or methods operated on the data transfer and circulation system 800, as well as application-related data such as contact data, messages sent and received, images, audio, video, etc. The memory 802 may be implemented by any type of volatile or non-volatile storage device or their combination, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic storage, flash memory, disks, or optical discs. The multimedia component 803 may include a screen and an audio component. The screen, for example, can be a touchscreen, and the audio component is used to output and/or input audio signals. For example, the audio component may include a microphone for receiving external audio signals. The received audio signals can be further stored in the memory 802 or sent via the communication component 805. The audio component also includes at least one speaker for outputting audio signals. The I/O interface 804 provides an interface between the processor 801 and other interface modules, which can be a keyboard, mouse, buttons, etc. These buttons can be virtual or physical. The communication component 805 is configured for wired or wireless communication between the data transfer and circulation system 800 and other devices. For wireless communication, such as Wi-Fi, Bluetooth, Near Field Communication (NFC), 2G, 3G, or 4G, or a combination thereof, the corresponding communication component 805 may include Wi-Fi module, Bluetooth module, NFC module.

In an embodiment, the data transfer and circulation device can be implemented by one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to perform the above data transfer and circulation method.

In another illustrative embodiment, a computer-readable storage medium comprising program instructions is provided, where the steps of the data transfer and circulation method described above are implemented when executed by a processor. For example, the computer-readable storage medium may be the above-mentioned memory 802 comprising program instructions, which can be executed by processor 801 of the data transfer and circulation system 800 to perform the above-mentioned data transfer and circulation method.

In correspondence to the embodiments mentioned above, another embodiment provides a computer-readable storage medium. The computer-readable storage medium described below corresponds to the data transfer and circulation method described above, and they can be mutually referenced accordingly.

A computer-readable storage medium, storing a computer program, where the steps of the data transfer and circulation method of the exemplary embodiments described above are implemented when the computer program is executed by a processor.

Specific examples of the computer-readable storage medium include USB drives, external hard drives, Read-Only Memory (ROM), Random Access Memory (RAM), disks, or optical discs, and other various readable storage media capable of storing program codes.

What is claimed is:

1. A data transfer and circulation method, comprising:
obtaining blockchain certificates respectively corresponding to multi-level supplier nodes;
sending the blockchain certificates to a core enterprise node, wherein the blockchain certificates are configured to trigger the core enterprise node to confirm user identities of the multi-level supplier nodes;
after receiving a confirmation feedback of the user identities of the multi-level supplier nodes sent from the core enterprise node, sending, by a first-level supplier node among the multi-level supplier nodes, a request for a completed work item to the core enterprise node;
obtaining a completed work item of the first-level supplier node, and generating a completed work item digital bill of the first-level supplier node based on a preset smart contract and the completed work item of the first-level supplier node;
performing one or more transfers among the multi-level supplier nodes according to the completed work item digital bill, and generating credit transfer digital certificates respectively corresponding to different levels of the multi-level supplier nodes based on the preset smart contract during a transfer process; and
requesting, by the multi-level supplier nodes, factoring information from a factor node based on the credit transfer digital certificates.

2. The data transfer and circulation method of claim 1, wherein a blockchain certificate of the first-level supplier node is generated through steps of:
randomly generating, by the first-level supplier node, a first data;
determining a primitive root information of the first-level supplier node based on the first data, and sending the primitive root information to the core enterprise node, wherein the primitive root information is configured to trigger the core enterprise node to calculate a first pseudo-anonymous identifier based on a second data and perform service exposure for the first pseudo-anonymous identifier, wherein the second data is randomly generated by the core enterprise node;
in response to the service exposure of the first pseudo-anonymous identifier, generating, by the first-level supplier node, a first multivariate array corresponding to the first-level supplier node based on the first pseudo-anonymous identifier; and
generating, by the first-level supplier node, the blockchain certificate of the first-level supplier node based on the first multivariate array and a timestamp at a current moment.

3. The data transfer and circulation method of claim 2, wherein step of obtaining the completed work item of the first-level supplier node, and generating the completed work item digital bill of the first-level supplier node based on the preset smart contract and the completed work item of the first-level supplier node comprises:
randomly generating, by the first-level supplier node, a third data;
generating a signature information based on the third data, the blockchain certificate of the first-level supplier node and the completed work item of the first-level supplier node; wherein the signature information is configured to trigger the core enterprise node to perform attribute information verification for the completed work item of the first-level supplier node, and a result of the attribute information verification is configured to trigger the core enterprise node to calculate a second pseudo-anonymous identifier and perform service exposure for the second pseudo-anonymous identifier; and the fourth data is randomly generated by the core enterprise node;
in response to the service exposure of the second pseudo-anonymous identifier, generating, by the first-level supplier node, a second multivariate array corresponding to the first-level supplier node based on the second pseudo-anonymous identifier, the third data and the fourth data; and
generating the completed work item digital bill of the first-level supplier node based on the preset smart contract and the second multivariate array.

4. The data transfer and circulation method of claim 1, wherein step of performing one or more transfers among the multi-level supplier nodes, and generating the credit transfer digital certificates respectively corresponding to different levels of the multi-level supplier nodes based on the preset smart contract during a transfer process comprises:
randomly generating, by a second-level supplier node among the multi-level supplier nodes, a first data, and randomly generating, by the first-level supplier node, a second data;
encrypting, by the second-level supplier node, an account information of a second-level supplier based on the first data to obtain an encrypted account information of the second-level supplier;
sending the completed work item digital bill and an account information of the first-level supplier node to the second-level supplier node;
verifying, by the second-level supplier node, the completed work item digital bill and the account information of the first-level supplier node;
when the completed work item digital bill and the account information of the first-level supplier node are verified to be correct, obtaining, by the second-level supplier node, a content information of the completed work item digital bill;
generating, by the second-level supplier node, a protocol data based on the encrypted account information of the second-level supplier and the content information of the completed work item digital bill, and sending the protocol data to the first-level supplier node;
verifying, by the first-level supplier node, content of the protocol data, and when a verification of the protocol data is passed, generating a first-level transfer notification based on the second data, and sending, the first-level transfer notification to the core enterprise node; wherein the first-level transfer notification is configured to trigger the core enterprise node to generate a first-level credit transfer digital notification based on a third data, and the third data is randomly generated by the core enterprise node; and
after receiving the first-level credit transfer digital notification, verifying, by the first-level supplier node, the first-level credit transfer digital notification, when the first-level credit transfer digital notification is verified to be valid, sending, by the first-level supplier node, a first-level credit transfer information to the second-level supplier node, and generating, by the second-level supplier node, a first-level credit transfer digital certificate based on the first-level credit transfer information.

5. A data transfer and circulation device, comprising:
a first obtaining module;
a first sending module;
a second sending module;
a second obtaining module;
a first processing module; and
a second processing module;
wherein the first obtaining module is configured for obtaining blockchain certificates respectively corresponding to multi-level supplier nodes;
the first sending module is configured for sending the blockchain certificates to a core enterprise node, wherein the blockchain certificates are configured to trigger the core enterprise node to confirm user identities of the multi-level supplier nodes;
the second sending module is configured for allowing a first-level supplier node among the multi-level supplier nodes to send a request for a completed work item to the core enterprise node after receiving a confirmation feedback of the user identities of the multi-level supplier nodes sent from the core enterprise node;
the second obtaining module is configured for obtaining a completed work item of the first-level supplier node, and generating a completed work item digital bill of the first-level supplier node based on a preset smart contract and the completed work item of the first-level supplier node;
the first processing module is configured for performing one or more transfers among the multi-level supplier nodes according to the completed work item digital bill, and generating credit transfer digital certificates respectively corresponding to different levels of the multi-level supplier nodes based on the preset smart contract during a transfer process; and
the second processing module is configured for allowing the multi-level supplier nodes to request factoring information from a factor node based on the credit transfer digital certificates.

6. The data transfer and circulation device of claim 5, wherein the first obtaining module comprises:
a first computing unit;
a second computing unit;
a third computing unit; and
a fourth computing unit;
wherein the first computing unit is configured for allowing the first-level supplier node to randomly generate a first data;
the second computing unit is configured for determining a primitive root information of the first-level supplier node based on the first data, and sending the primitive root information to the core enterprise node, wherein the primitive root information is configured to trigger the core enterprise node to calculate a first pseudo-anonymous identifier based on a second data and perform service exposure for the first pseudo-anonymous identifier, and the second data is configured to be randomly generated by the core enterprise node;
the third computing unit is configured for, in response to the service exposure of the first pseudo-anonymous identifier, allowing the first-level supplier node to generate a first multivariate array corresponding to the first-level supplier node based on the first pseudo-anonymous identifier; and
the fourth computing unit is configured for allowing the first-level supplier node to generate a blockchain certificate of the first-level supplier node based on the first multivariate array and a timestamp at a current moment.

7. The data transfer and circulation device of claim 6, wherein the second obtaining module comprises:
a fifth computing unit;
a sixth computing unit;
a seventh computing unit; and
an eighth computing unit;
wherein the fifth computing unit is configured for allowing the first-level supplier node to randomly generate a third data;
the sixth computing unit is configured for generating a signature information based on the third data, the blockchain certificate of the first-level supplier node and the completed work item of the first-level supplier node; wherein the signature information is configured to trigger the core enterprise node to perform attribute information verification for the completed work item of the first-level supplier node, and a result of the attribute information verification is configured to trigger the core enterprise node to calculate a second pseudo-anonymous identifier based on a fourth data and perform service exposure for the second pseudo-anonymous identifier; and the fourth data is configured to be randomly generated by the core enterprise node;
the seventh computing unit is configured for, in response to the service exposure of the second pseudo-anonymous identifier, allowing the first-level supplier node to generate a second multivariate array corresponding to the first-level supplier node based on the second pseudo-anonymous identifier, the third data and the fourth data; and
the eighth computing unit is configured for generating the completed work item digital bill of the first-level supplier node based on the preset smart contract and the second multivariate array.

8. The data transfer and circulation device of claim 5, wherein the first processing module comprises a first transfer module, and the first transfer module comprises:
a first processing unit;
a first encryption unit;
a first sending unit;
a first verification unit;
a second processing unit;
a third processing unit;
a fourth processing unit; and
a fifth processing unit;
wherein the first processing unit is configured for allowing a second-level supplier node among the multi-level supplier nodes to randomly generate a first data, and allowing the first-level supplier node to randomly generate a second data;
the first encryption unit is configured for allowing the second-level supplier node to encrypt an account information of a second-level supplier based on the first data to obtain an encrypted account information of the second-level supplier;
the first sending unit is configured for sending the completed work item digital bill and an account information of the first-level supplier node to the second-level supplier node;
the first verification unit is configured for allowing the second-level supplier node to verify the completed work item digital bill and the blockchain certificate of the first-level supplier node;
the second processing unit is configured for allowing the second-level supplier node to obtain a content information of the completed work item digital bill when the completed work item digital bill and the account information of the first-level supplier node are verified to be correct;
the third processing unit is configured for allowing the second-level supplier node to generate a protocol data based on the encrypted account information of the second-level supplier and the content information of the completed work item digital bill, and send the protocol data to the first-level supplier node;
the fourth processing unit is configured for allowing the first-level supplier node to verify content of the protocol data, and when a verification of the protocol data is passed, generating a first-level transfer notification based on the second data, and sending the first-level transfer notification to the core enterprise node; wherein the first-level transfer notification is configured to trigger the core enterprise node to generate a first-level credit transfer digital notification based on a third data, and the third data is configured to be randomly generated by the core enterprise node; and
the fifth processing unit is configured for, after receiving the first-level credit transfer digital notification, allowing the first-level supplier node to verify the first-level credit transfer digital notification, allowing the first-level supplier node to send a first-level credit transfer information to the second-level supplier node when the first-level credit transfer digital notification is verified to be valid, and generating a first-level credit transfer digital certificate based on the first-level credit transfer information.

9. A data transfer and circulation system, comprising:
a memory; and
a processor;
wherein the memory is configured for storing a computer program; and
the processor is configured for executing the computer program to implement the data transfer and circulation method of claim 1.

10. A computer-readable storage medium, wherein a computer program is stored on the computer-readable storage medium, and the computer program is configured to be executed by a processor to implement the data transfer and circulation method of claim 1.
